(19) United States
(12) Patent Application Publication
(10) Pub. No.: US 2010/0073706 A1
(43) Pub. Date: Mar. 25, 2010

(54) PRINTING OF PROOF COPY WITH REDUCED RESOURCE USAGE IN A PRINT SHOP MANAGEMENT SYSTEM

(75) Inventor: Sam Chan, West Covina, CA (US)

Correspondence Address: YING CHEN;Chen Yoshimura LLP, 255 S. GRAND AVE., # 215, LOS ANGELES, CA, 90012, US

(73) Assignee: KONICA MINOLTA SYSTEMS LABORATORY, INC., Huntington Beach, CA (US)

(21) Appl. No.: 12/235,516

(22) Filed: Sep. 22, 2008

(51) Int. Cl. G06F 3/12

(52) U.S. Cl. 358/1.15

(57) ABSTRACT

A proof copy printing method implemented in a print shop. When a user desires to print a proof copy of a print job while reducing resource usage, the user activates a GUI screen, which allows the user to conveniently set multiple parameters that will achieve reduced resource usage. When printing the proof copy, the values set on the GUI screen are used to temporarily override the corresponding parameter values specified in the job ticket without modifying the job ticket itself. When the user desires to print the job normally, the user activates the GUI screen to cancel the proof mode. The system then prints the job using the job parameter values specified in the job ticket.

### BACKGROUND OF THE INVENTION

1. Field of the Invention

This invention relates to print job processing method and apparatus, and more particularly, it relates to print job processing method and apparatus implemented in a print shop for printing proof copies of documents that reduces resource usage.

2. Description of Related Art

In an environment that processes a large number of print jobs with multiple printers, there has been a need to manage print jobs efficiently in an organized fashion. Examples of such an environment are professional print shops and print/copy departments at large organizations, where a variety of print requests, such as large-volume duplication and large document printing, needs to be processed and completed by utilizing multiple printers within a short turn-around time. These environments are collectively referred to as “print shops” in this application. Each printing job processed by the print shop management system is described by a job ticket that specifies a source file containing a document to be printed, the size, color and the type of the paper on which the document should be printed, the printing resolution, duplex or single-side printing, and certain finishing conditions, such as book, staple, collate printing, etc., depending on a print job requester's needs. In order to process a large volume of print jobs that each differ in terms of these job parameters, a print shop utilizes multiple commercial grade printers, including black & white and color printers. Each of these printers has limitations on available printer settings, such as the paper size, the paper type, resolution settings, etc. In addition, the print shop employs various finishing devices, such as collators, staplers, hole punchers, folding machines, binding machines, etc. A print shop management system is typically implemented on a print shop management apparatus such as a control computer connected to the printers to submit (i.e. assign) each print job to one or more printers and finishing devices to produce the print job.

Printing methods aimed at saving resource have been described. For example, U.S. Pat. No. 7,062,190 (U.S. Pat. Appl. Pub. No. 2002/0071689) describes “[a]n image forming apparatus [which] includes resource amount designation keys for allowing a user to designate an amount of resource, display control keys for controlling to display a plurality of setting options which enable image formation with the designated amount of resource, selection keys for allowing the user to select a desired setting option from the plurality of setting options displayed, and setting keys for performing image formation setting with the setting option selected by the selection keys.” (Abstract.)

### SUMMARY

Accordingly, the present invention is directed to a printing method for printing proof copies of documents that substantially obviates one or more of the problems due to limitations and disadvantages of the related art.

An object of the present invention is to provide a method for printing proof copies that is easy to use, saves time, and reduces resource usage and cost of the proof run.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and/or other objects, as embodied and broadly described, the present invention provides for a print shop management system, a method for printing a print job, the print job including a job ticket specifying values of a plurality of job parameters, where the method includes: (a) receiving the print job including the job ticket; (b) receiving one or more user inputs specifying values of a subset of the plurality of job parameters; and (c) printing the print job according to the job parameters specified in the job ticket with the subset of the job parameters being overridden by the values specified by the user inputs without modifying the job ticket. The subset of job parameters defines proof printing with reduced resources usage. The method further includes, after step (c), printing the print job according to the job parameters specified in the job ticket.

In another aspect, the present invention provides a computer program product that causes a data processing apparatus to perform the above method.

In another aspect, the present invention provides a method for printing a print job using a print shop management system, the print job including a job ticket specifying values of a plurality of job parameters, where the method includes: (a) a user activating an input screen of the print shop management system, the input screen including one or more input means for inputting values of the subset of job parameters; (b) the user selecting a settings selection input means; (c) the user inputting values of the subset of the plurality of job parameters using the plurality of input means; (d) the user submitting the job for printing; and (e) the print shop management system printing the print job according to the job parameters specified in the job ticket with the subset of the job parameters being overridden by the values specified by the user inputs without modifying the job ticket. The subset of job parameters defines proof printing with reduced resources usage. The method further includes, after step (e): (f) the user activating the input screen of the print shop management system; (g) the user de-selecting the settings selection input means; (h) the user submitting the job for printing; and (i) the print shop management system printing the print job according to the job parameters specified in the job ticket.

It is to be understood that both the foregoing general description and the following detailed description are exemplary and explanatory and are intended to provide further explanation of the invention as claimed.

### BRIEF DESCRIPTION OF THE DRAWINGS

FIG. 1A is a flow diagram illustrating a process of setting job parameters and submitting the job in a proof mode.

FIG. 1B is a flow diagram illustrating a method of cancelling the proof mode after a proof run.

FIG. 2 illustrates a GUI screen used for submitting a job in a proof mode and for cancelling the proof mode.

FIG. 3 illustrates a print shop system in which embodiments of the present invention may be implemented.

### DETAILED DESCRIPTION OF PREFERRED EMBODIMENTS

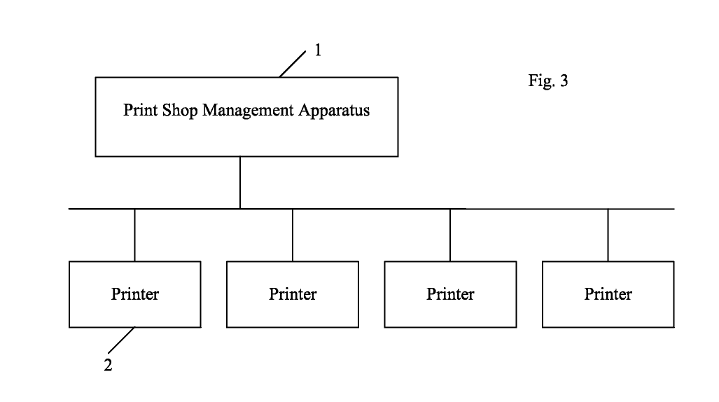

FIG. 3 illustrates a print shop system in which embodiments of the present invention may be implemented. The print shop system includes a print shop management apparatus 1 (e.g. a control computer) and printers 2 and other devices of the print shop connected to each other by a data communication line or network such as an LAN (Local Area Network). The method is implemented by the print shop management system software, which is stored in a storage (e.g., a hard disk drive) of the print shop management apparatus 1 and is executed by the print shop management apparatus 1.

When handling a print job using the print shop management system, a user may wish to print one or more proof copies (also referred to as preview or draft copies) of a document for review purposes. In some cases, the proofs must be identical to the final print product. In other cases, however, the proofs do not need to be of the highest quality; for example, they may only need to be legible. In the latter instances, it is desirable if the user is able to reduce the use of printing resources to reduce the overall cost of the print job.

For each given print job, a number of job parameters can be adjusted to reduce resource usage. These parameters include, for example, print type (single-sides, double-sided, etc.), 2-in-1 (or N-in-1 in general, i.e. printing two or more pages on each sheet in reduced size), toner save (using toner save mode), color (printing the document in black and white even though it contains color), and staple (e.g. turning it Off). In a conventional print shop management system, the user is able to modify any of these parameters in the job ticket if he wants to reduce resource usage for a proof run on the print job. One problem with such a conventional system, however, is that these settings are often displayed on different screens of the software GUI (graphical user interface), and modifying all of the settings can be cumbersome and time-consuming. Another problem is that if the user modifies any of the settings for purposes of a proof printing, the user must later re-modify the settings, by going to the different screens of the GUI, when the actual print job is processed. This increases the chances for errors (and the associated cost) caused by a user forgetting to re-modify the settings before running the actual print job.

Embodiments of the present invention provide an easy to use method for reducing resource usage when printing a proof run. All settings that can be adjusted for a proof run are displayed on a single screen on the GUI (referred to as the Minimize Print Resource Settings screen herein). By selecting a checkbox, the values of these settings as specified by the job ticket are temporarily overridden by the values set on the Minimize Print Resource Settings screen. The job ticket itself is not modified. When the proof runs are complete and the user wishes to process the job normally, the user de-selects the checkbox and the values of all relevant settings return to the values specified in the job ticket.

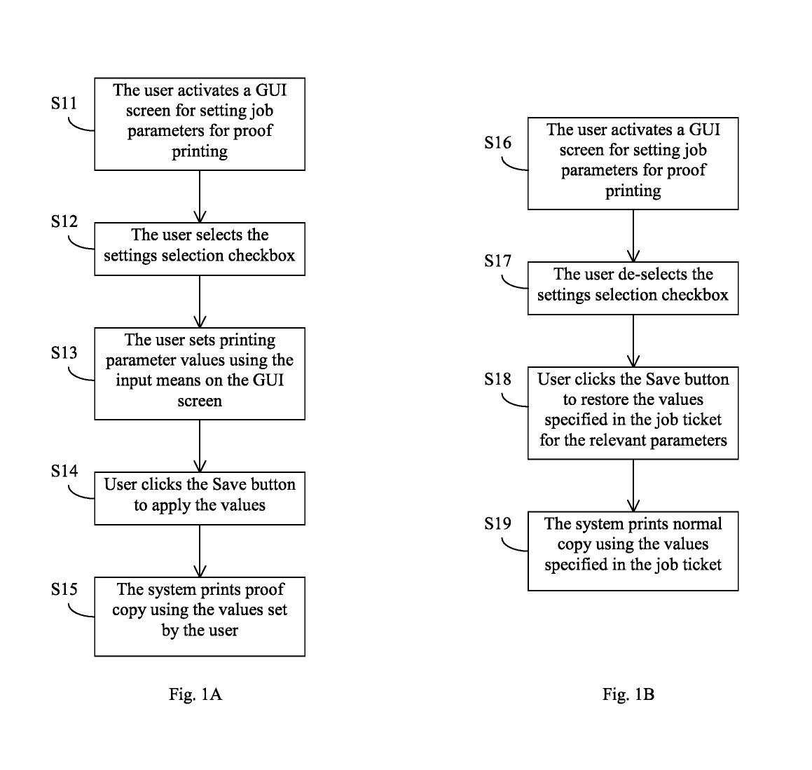

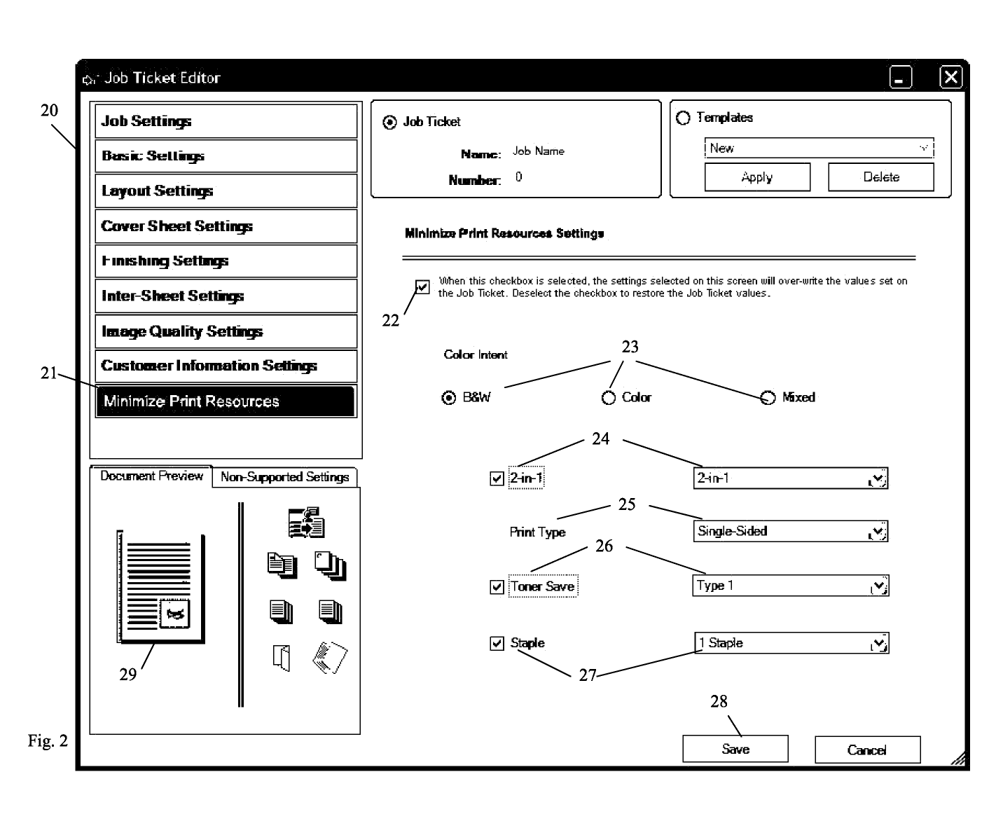

The proof copy printing method is described in more detail with reference to FIGS. 1A, 1B and 2. FIG. 1A illustrates a process of setting certain job parameters and submitting the job for a proof run (i.e. printing in a proof mode). FIG. 1B illustrates a method of cancelling the proof mode after a proof run so that the job can be submitted for normal printing. FIG. 2 illustrates a GUI screen used for submitting a job for a proof run and cancelling the proof mode.

As shown in FIG. 1A, when the user desires to print a job as a proof with reduced resource usage, the user activates a GUI screen for setting job parameters for proof printing, referred to as Minimize Print Resources Settings screen in this example (step S11). In the example shown in FIG. 2, the Minimize Print Resources Settings screen is activated by clicking a button 21 (labeled Minimize Print Resources) in a job ticket editor window 20. When the button 21 is clicked, various input means are displayed in an area of the window 20 for receiving user input related to the proof mode. The display includes a settings selection input means 22 (a checkbox in this example). The settings selection input means may optionally include explanatory text next to the checkbox 22. In this example, the text reads: “When this checkbox is selected, the settings selected on this screen will override the values set on the Job Ticket. Deselect the checkbox to restore the Job Ticket values.” The settings selection checkbox 22 is de-selected by default. When it is de-selected, other input means on the Minimize Print Resources Settings display area are inactive (grayed out).

Next, the user selects (checks) the settings selection checkbox 22 (step S12). This indicates that the user desires to use a proof printing mode, i.e., allowing the parameter values set on this GUI screen to override the values specified in the job ticket. When this checkbox is selected, a number of input means 23-27 on the GUI become activate (un-grayed) for the user to input job parameters. The user then uses the various input means 23-27 to set the various job parameters (step S13).

The color intent input means 23 includes a plurality of radial buttons for selecting printing in black and white, color, and mixed (both black and white and color in the document). If the document contains color pages but color is not critical for the proof, the user can select the B&W button. The “2-in-1” input means 24 includes a checkbox for the user to indicate whether N-in-1 printing is desired, and a drop-down menu (un-grayed when the checkbox is checked) for the user to indicate the number of pages per sheet, such as 2-in-1, 4-in-1, etc. The Print Type input means 25 includes a drop-down menu for the user to indicate whether the printing will be single-sided, double sided, etc. The Toner Save input means 26 includes a checkbox for the user to indicate whether printing in a toner saver mode is desired, and a drop-down menu (un-grayed when the checkbox is checked) for the user to indicate the type of toner saver mode, such as Type 1, Type 2, etc. (the different types of toner saver mode use different methods or offer different degrees of toner saving). The Staple input means 27 includes a checkbox for the user to indicate whether the printed copy will be stapled, and a drop-down menu (un-grayed when the checkbox is checked) for the user to indicate the number of staples, such as 1, 2, etc.

In some embodiments, a document preview 29 is provided in the job ticket editor window 20. The document preview may be implemented in different ways with respect to the proof print settings. In one implementation, the appearance of the document preview 29 is updated when various settings on the Minimize Print Resources Settings screen are changed. For example, if the B&W button is selected in the color intent input means 23, the document preview will display a black and white preview image, and if color is selected, it will display a color preview image. Similarly, if 2-in-1 setting is selected, the preview image will show a 2-in-1 layout. The document preview is updated automatically without the user clicking the Save button 28. Optionally, an indication such as the text “Proof Printing” may be displayed adjacent the document preview 29 so that the user can easily recognize that a proof copy reflecting the Minimize Print Resources settings is being previewed. This implementation allows the user to visualize how the various Minimize Print Resources settings will affect the proof print.

In an alternative implementation, the document preview 29 always displays a preview image according to the settings specified in the job ticket, not those specified on the Minimize Print Resources Settings screen. Thus, for example, if the original job ticket setting is color, a color preview image will be displayed, even if the user selects the B&W button for the color intent input 23.

After the parameter values are set, the user clicks a Save button 28 to apply the values (step S14). The print shop management system prints the job as a proof using the parameter values set by the user on the Minimize Print Resources Settings screen, which overrides the corresponding parameter values in the job ticket (step S15). The job ticket itself is not changed.

As shown in FIG. 1B, after the proof copy is printed, if the user desires to print the job as a normal job using the parameter values specified in the job ticket, the user again activates the Minimize Print Resources Settings GUI screen (step S16). The user de-selects (un-checks) the settings selection checkbox 22 (step S17) to cancel the proof printing mode. When the settings selection checkbox 22 is de-selected, input means 23-27 become invalid and the user does not need to re-set their values individually. The user clicks the Save button 28 (step S18) to indicate that the values specified in the job ticket (which was preserved when the user submitted the proof run) are to be restored for these parameters. The print shop management system prints the document normally using the parameter values specified in the job ticket (step S19). In one implementation, the printing step (step S19) may occur immediately after the user clicks the Save button 28. In another implementation, clicking the Save button 28 merely restores the values to those specified in the job ticket; the system performs subsequent processing steps normally (such as determining which printer or printers and finishing devices the job is to be assigned to, applying other management policies to the print job, etc.) before actually printing the job.

Alternatively, instead of using the Minimize Print Resources Settings GUI screen to cancel the proof mode, a different screen can be used, or a button (e.g. the button may be labeled “Submit for normal printing; ignore minimize print resources settings”) can be used to submit the print job for normal printing where the settings previously specified on the Minimize Print Resources Settings screen are ignored. As an alternative embodiment, after the proof copy is printed, the print shop management system automatically restores the relevant parameters to the values specified in the job ticket. In other words, the settings specified in the Minimize Print Resources Settings screen are applied only once. Thus, the user does not need to do anything affirmative to cancel the proof printing mode. If the user needs to print another proof copy, the user will re-perform steps S11 to S14.

It should be noted that although specific examples of displays and input means are described and shown in FIG. 2, the invention is not limited to the specifics of the user interface displays. The invention may be implemented using any forms of user interface displays, as long as the user interface display includes input means that allows the user to specify various settings. The input means may be buttons, checkboxes, radio buttons, text input fields, drop-down menus, pop-up menus, icons, tabs for bringing up different sheets, separate windows, etc., or combinations thereof, or any other suitable structure of allowing the user to input information to the computer. The computer software designs for suitable structures of the input means are familiar to a person of ordinary skill in the programming field. Therefore, detailed descriptions for these structures are omitted here. The term “user interface display” is used to generally mean any suitable screen display that displays information to the user and/or allows the user to input commands and other information, and is not limited to any specific form of display, and may include a series of consecutive displays.

The proof copy printing method according to embodiments of the present invention has the advantages that it consolidates and simplifies existing functionality, addresses resource reduction (environmentally friendly function), and minimizes time and error.

Although the printing method is described above in the context of printing proof copies, the method can be more generally applied in other practical areas. More generally, embodiments of the present invention provides a printing method which allows a user to set one or more job parameters to desired values, without modifying the job ticket, and submit the job for a special-purpose printing with the desired parameter values. During the special-purpose printing, the parameter values set by the user temporarily override the corresponding parameter values specified in the job ticket. The parameters are restored to the values specified in the job ticket either automatically after one printing, or manually by the user. A convenient GUI screen is provided to allow the user to change all parameters related to the special purpose (e.g. reducing resource usage) on one screen, and to easily restore the parameters to the original values specified in the job ticket.

It will be apparent to those skilled in the art that various modification and variations can be made in the printing method of the present invention without departing from the spirit or scope of the invention. Thus, it is intended that the present invention cover modifications and variations that come within the scope of the appended claims and their equivalents.

What is claimed is:

1. In a print shop management system, a method for printing a print job, the print job including a job ticket specifying values of a plurality of job parameters, the method comprising:
(a) receiving the print job including the job ticket;
(b) receiving one or more user inputs specifying values of a subset of the plurality of job parameters; and
(c) printing the print job according to the job parameters specified in the job ticket with the subset of the job parameters being overridden by the values specified by the user inputs without modifying the job ticket.

2. The method of claim 1, wherein the subset of job parameters defines proof printing with reduced resources usage.

3. The method of claim 2, wherein the subset of job parameters includes one or more of a print type, N-in-1 printing, toner save mode, color, and staple.

4. The method of claim 1, wherein step (b) comprises:
(b1) receiving a first user input to activate an input screen;
(b2) displaying the input screen, which includes one or more input means for inputting values of the subset of job parameters; and
(b3) receiving one or more second user inputs via the input means, the second user inputs specifying one or more values of the subset of job parameters.

5. The method of claim 1, further comprising:
(d) after step (c), printing the print job according to the job parameters specified in the job ticket.

6. The method of claim 5, wherein step (d) includes receiving a third user input which indicates that the values of job parameters specified in the job ticket are to be used for printing.

7. The method of claim 1, further comprising:
(e) displaying a preview of the print job in accordance with the one or more user inputs received in step (b).

8. The method of claim 1, further comprising:
(f) displaying a preview of the print job in accordance with job parameters specified in the job ticket regardless of the one or more user inputs received in step (b).

9. A method for printing a print job using a print shop management system, the print job including a job ticket specifying values of a plurality of job parameters, the method comprising:
(a) a user activating an input screen of the print shop management system, the input screen including one or more input means for inputting values of the subset of job parameters;
(b) the user selecting a settings selection input means;
(c) the user inputting values of the subset of the plurality of job parameters using the plurality of input means;
(d) the user submitting the job for printing; and
(e) the print shop management system printing the print job according to the job parameters specified in the job ticket with the subset of the job parameters being overridden by the values specified by the user inputs without modifying the job ticket.

10. The method of claim 9, wherein the subset of job parameters defines proof printing with reduced resources usage.

11. The method of claim 9, wherein the subset of job parameters includes one or more of a print type, N-in-1 printing, toner save mode, color, and staple.

12. The method of claim 9, further comprising, after step (e):
(f) the user activating the input screen of the print shop management system;
(g) the user de-selecting the settings selection input means;
(h) the user submitting the job for printing; and
(i) the print shop management system printing the print job according to the job parameters specified in the job ticket.

13. A computer program product comprising a computer usable medium having a computer readable program code embedded therein for controlling a data processing apparatus in a print shop, the computer readable program code configured to cause the data processing apparatus to execute a process for printing a print job, the print job including a job ticket specifying values of a plurality of job parameters, the process comprising:
(a) receiving the print job including the job ticket;
(b) receiving one or more user inputs specifying values of a subset of the plurality of job parameters; and
(c) printing the print job according to the job parameters specified in the job ticket with the subset of the job parameters being overridden by the values specified by the user inputs without modifying the job ticket.

14. The computer program product of claim 13, wherein the subset of job parameters defines proof printing with reduced resources usage.

15. The computer program product of claim 14, wherein the subset of job parameters includes one or more of a print type, N-in-1 printing, toner save mode, color, and staple.

16. The computer program product of claim 13, wherein step (b) comprises:
(b1) receiving a first user input to activate an input screen;
(b2) displaying the input screen, which includes one or more input means for inputting values of the subset of job parameters; and
(b3) receiving one or more second user inputs via the input means, the second user inputs specifying one or more values of the subset of job parameters.

17. The computer program product of claim 13, wherein the process further comprises:
(d) after step (c), printing the print job according to the job parameters specified in the job ticket.

18. The computer program product of claim 17, wherein step (d) includes receiving a third user input which indicates that the values of job parameters specified in the job ticket are to be used for printing.

19. The computer program product of claim 13, wherein the process further comprise:
(e) displaying a preview of the print job in accordance with the one or more user inputs received in step (b).

20. The computer program product of claim 13, wherein the process further comprise:
(f) displaying a preview of the print job in accordance with job parameters specified in the job ticket regardless of the one or more user inputs received in step (b).
